(19) United States
(12) Patent Application Publication
(10) Pub. No.: US 2007/0203835 A1
(43) Pub. Date: Aug. 30, 2007

(54) Automated teller service using wireless telephony

(76) Inventor: Yigang Cai, Naperville, IL (US)

Correspondence Address: Werner Ulrich, 434 Maple Street, Glen Ellyn, IL, 60137-3826, US

(21) Appl. No.: 11/364,717

(22) Filed: Feb. 27, 2006

(51) Int. Cl. G06Q 40/00

(52) U.S. Cl. 705/43

(57) ABSTRACT

This invention relates to a method and apparatus for requesting ATM transactions via a separate cellular connection to arrangements for accessing a customer's account and controlling an ATM machine in response to data provided over the separate connection. A customer accesses an application server of a telephony service provider network. The application server provides a menu to steer the customer's actions. The customer provides data identifying a local ATM machine, the customer and the requested transaction. The application server accesses a payment server which communicates with the customer's bank or other financial institution. The payment server then communicates with a bank or other financial institution for controlling the ATM machine to deliver cash to the customer. Advantageously, the customer can receive the benefit of a menu for guiding his/her actions. Advantageously, the customer has added flexibility in specifying the source of the ATM cash or the destination of an ATM deposit.

### TECHNICAL FIELD

This invention relates to a method and apparatus for communicating between a customer at an automated teller machine (ATM) using a wireless telephone device to control the ATM transactions.

### BACKGROUND OF THE INVENTION

Automated teller machines (ATMs) are now widely available for permitting bank customers to withdraw cash, deposit cash or check, or to transfer funds of any financial institution using a debit card or credit card. An automated clearing house (ACH) is used to settle electronic funds transfers between financial institutions and to register at a bank the funds withdrawn or deposited by a customer.

A problem of this arrangement is that consumer can only use his/her bank card or credit card to withdraw cash from the ATMs and cannot communicate with his/her bank as part of the transaction. With fast growing of wireless communication, consumer will be willing to use wireless handset to perform cash withdrawing, fund transferring together with existing financial network and telephony network. Currently, wireless devices (cell phone, PDA) have been used for e-commerce business, such as parking meter, vendor machine, purchase movie and sport tickets, point of sales, in which the wireless subscriber pays of mini- payment through prepaid account or credit card account which managed by telecommunication service providers through e-commerce application server. Wireless subscribers can also recharge his/her telephony or e-commerce prepaid account with scratch card or credit card by wireless device or retailer terminals. The automated clearing house (ACH) will settle electronic funds transferring between telephony service provider and merchant sectors. However, there is no ability to use these broader capabilities with automated teller machines. In the prior art, cash withdrawal from an ATM machine can only be performed if the customer has a bank card or credit card.

### SUMMARY OF THE INVENTION

The above problem is substantially alleviated and a contribution is made over the prior art in accordance with this invention wherein a customer identifies an ATM and transmits information concerning a transaction to a telephony service provider network via a wireless telephone; the telephony service provider network communicates with a financial network for accomplishing the financial transaction. The customer can use a wireless device to perform financial transactions using telephony accounts, control withdrawal of cash from his/her prepaid account; with an interface between the telephone network and financial network, the ATM can provide cash withdraw from the prepaid account. In accordance with this invention, financial transaction can also made from telephone accounts of pre/postpaid, bank card/credit card accounts stored in telephone accounts; no physical cards are needed for ATM transactions; for a cash withdrawal, the customer's bank or other financial institution signals the ATM to supply the cash. In addition, the customer takes requested cash from the ATM or deposits cash or a check into the ATM as in the prior art. Advantageously, using these arrangements the customer can specify an ATM transaction using the wireless device and can receive the type of sophisticated guidance (e.g., menus) made possible through an interaction over the telephony service provider network with a server.

In accordance with one preferred embodiment of the invention, the wireless subscriber can walk or drive to an ATM which belongs to a financial institution having an agreement with the telephony service provider. The subscriber dials a special number or browses a website using his/her wireless device. The customer is then connected to an automated teller application server which provides automated teleservice for the wireless subscriber. The server communicates with a financial network. The services that can be offered include the withdrawal of cash, the deposit of cash or a check, or the transfer of funds from, to or between prepaid accounts, postpaid accounts, bank card accounts and credit card accounts. If cash or checks are deposited, they are inserted in an envelope fed into the ATM for subsequent retrieval by the financial institution serving the ATM.

For transferring funds from bank card or credit card accounts which are not associated with the telephony payment service to or from any other telephone accounts of pre/postpaid, bank card/credit card account stored in telephone accounts, the subscriber inserts a credit or debit card into the ATM machine which reads the account information and transmits it to the connected bank.

For transactions which are associated with the telephony payment service or with financial institutions supported by the service provider, the customer must enter the location identification of the ATM and account authorization identification. This is likely to include security information such as a personal identification number or a fingerprint or voice, eye, or face recognition. The security information is transported to the application server for validation and checks to make sure that the customer is authorized to make the appropriate transaction from the particular ATM location.

The wireless automated teller transaction can be performed using an interactive voice response, text messages, or multimedia messages, as supported by the wireless station and the application server.

The application server converts the transaction requests into specific requests sent to an e-commerce gateway for accessing payment servers. The gateway can access the payment server which could be a prepaid server or e- commerce server for telephony e-commerce. The gateway relays the requests to the prepaid or postpaid telephony or e-commerce payment server. The payment server communicates with a billing system. The billing system generates billing invoices and also connects to the ACH to complete transactions.

The automated transaction results are then displayed on the screens of the wireless device and/or the ATM. The confirmation will be printed out from the ATM or as a short message service message, or as e-mail to the subscriber as identified by the subscriber's cellular device.

Advantageously, the mechanisms of the wireless telephony system can check the caller's mobile telephone number to ensure that the correct customer is calling and to protect against the use of reported stolen cellular devices.

### BRIEF DESCRIPTION OF THE DRAWINGS

FIG. 1 is a block diagram illustrating the operation of Applicant's invention; and

FIG. 2 is a flow diagram illustrating the withdrawal of cash in accordance with the teachings of Applicant's invention.

### DETAILED DESCRIPTION

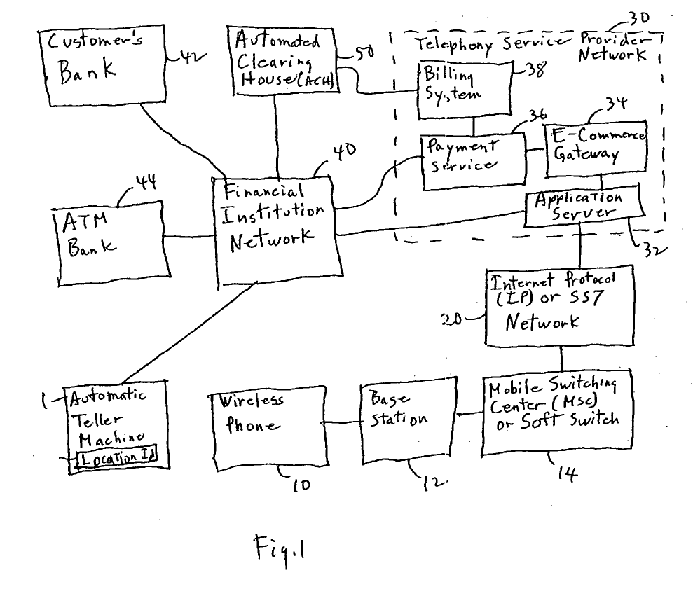

FIG. 1 is a block diagram illustrating the operation of Applicant's invention. A customer walks or drives up to a conventional automated teller machine (ATM) 1 which is already equipped to cooperate with a wireless specification of the customer transaction. The ATM machine is identified by a location identifier 3. The customer has a wireless device 10 connected via a base station 12 to a switch such as a mobile switching center via an Internet protocol or an SS7 public switched telephone network or a soft switch 14 which is connected via an Internet protocol to a telephony service provider network 30. The wireless device communicates with an application server 32 of the telephony service provider network. The application server is connected directly to a financial institution network 40. The telephony service provider network is connected to the customer's bank 42 and to an ATM Bank 44 serving the ATM 1. The application server is also connected via an e-commerce gateway 34 to a payment service application server 36. The payment service application communicates via the financial institution network 40 with the customer's bank 42 and also communicates with a billing system 38 which is connected to the automated clearing house (ACH) 50. The ACH performs standard clearing house functions and communicates account updating information via the financial institution network 40 to the customer's bank for updating the customer's basic account information.

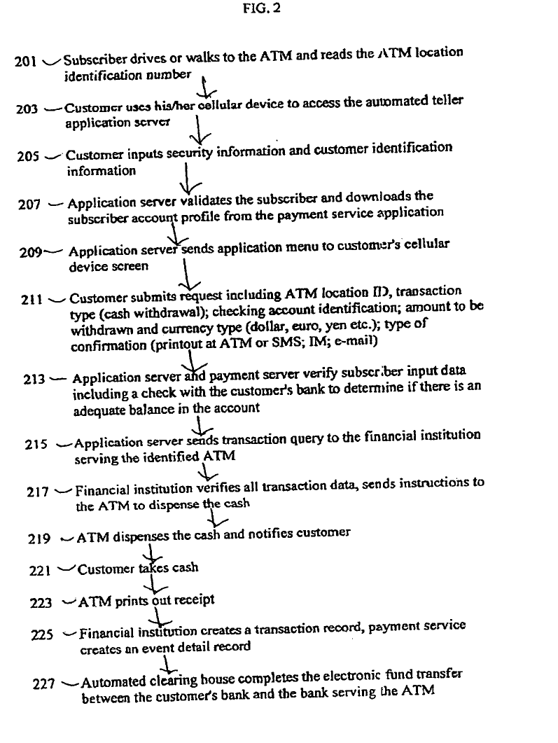

FIG. 2 is a flow diagram illustrating the processing of a cash withdrawal request. The subscriber drives or walks up to the ATM and checks the ATM location identification number (action block 201). The customer uses a cellular phone to access the automated teller application server (action block 203). The customer inputs a customer identification and a security code (such as a personal identification number, an eye or face picture from a cellular device camera, a fingerprint) (action block 205). The actions for providing the customer's data can be steered by a menu provided from the application server. The application server then validates the subscriber information and downloads the subscriber account profile from the payment services application (action block 207). The application display appears on the cellular device screen and, optionally, on the ATM screen (action block 209). The subscriber then submits the ATM request (action block 211). The subscriber inputs the ATM location identification number, selects the transaction type (in this case, a cash withdrawal), selects a checking account number from within the bank account (the customer may have several accounts in the same bank), indicates the amount of money to be withdrawn and the currency type (such as dollar, euro, yen), and selects the type of confirmation (paper confirmation from the ATM, or as a short message service message or an instant message or e-mail).

The application server and the payment server verify the subscriber input request data including a check with the customer's bank 42 to see if the customer's account has an adequate balance to meet the cash withdrawal request (action block 213). The application server then sends a transaction query to the bank 44 connected to the identified ATM (action block 215). The financial institution verifies all transaction data and then instructs the ATM to dispense the appropriate amount of money (action block 219). The ATM dispenses the requested cash (action block 219). The subscriber takes the cash (action block 221). The selected paper confirmation specified in action block 211 is created (action block 223).

The ATM bank 44 creates a transaction record and the payment service creates an event detail record (action block 225). Finally, the automated clearing house completes the electronic fund transfer between the customer's bank 42 and the bank 44 connected to the ATM (action block 227).

Similar scenarios can be used to permit a customer to deposit cash or checks in an envelope provided at the ATM station, and transfer funds to wireless subscriber prepaid/postpaid accounts, bank card accounts or credit card accounts associated with telephony payment service.

For transferring funds from a bank card or credit card account which is not associated with the telephony payment service to any other accounts, or vice versa, the subscriber must insert the card into the ATM machine which will read account information; for credit cards, the subscriber may need to input expiration data and security code.

The subscriber will have to input account authorization identification. The application server will validate it with its own database or with telephony payment service. The payment service could be a prepaid service or postpaid service. The payment service can hold subscriber's accounts, like prepaid, postpaid, credit card; bank card accounts. The payment service server will acknowledge to the application server the subscriber's account information. The payment service server will interface with the financial institution network to conduct automated teller transaction and with the ACH for automated funds transferring (between telephony and financial institution).

The subscriber will have to provide a security pass code for any wireless automated teller transactions. The security pass code could be password keyed in on the wireless device, or finger print, or voice, eye or face recognition by the wireless device or the ATM device. The wireless device or the ATM transport the security pass code to the application server which validate the pass code whether the subscriber is allowed for the wireless automated teller transaction or allowed in this particular ATM location (the application server keeps an authorization mapping table of subscriber ID, pass codes (and types) and ATM location IDs.

The wireless automated teller transaction can be done by voice (interactive voice response), text message or multimedia messages (web browsing) supported at the wireless handset and application server.

The application server will convert transactions into special requests sending off to the e-commerce gateway which relays the requests to the payment service. The payment service then interface with the financial institution for the transaction. The financial institution instructs the ATM to complete the transactions.

The automated transaction results will be displayed on the screens of the wireless device and/or the ATM. The automatic transaction confirmation will be a printout paper from the ATM or an SMS or e-mail to the subscriber handset.

The application server, payment service server and financial institution server will sync up the transactions automatically. The legal and security agreements shall be set between finance and telephone sectors.

The above description is of one preferred embodiment of Applicant's invention. Other embodiments will be apparent to those of ordinary skill in the art. The invention is limited only by the attached claims.

I claim:

1. A method of performing an automated teller machine (ATM) transaction comprising the steps of:
identifying a target ATM terminal;
transmitting data from a cellular device, said data for identifying said target ATM terminal, specifying a requested ATM transaction, and specifying a customer identification, toward means for accessing an account of said customer;
responsive to accessing said account, transmitting a request to a financial institution controlling said ATM terminal; and
transmitting a request from said financial institution controlling said ATM terminal to said ATM terminal to complete said requested transaction.

2. The method of claim 1 further comprising the steps of:
responsive to accessing said account, transmitting a billing request to an automated clearing house; and
transmitting requests from said automated clearing house to a bank of said customer and to said financial institution controlling said ATM terminal to adjust customer balances and request inter-bank transfers corresponding to said requested ATM transaction.

3. The method of claim I wherein the step of transmitting data toward means for accessing said account of said customer comprises the steps of:
establishing a connection from a cellular device of a customer to an application server of a telephony service provider network;
within said telephony service provider network, establishing a data connection between said application server and a payment server;
inputting data from said cellular device for identifying said customer and for specifying a requested ATM transaction;
transmitting a request from said payment service server to a financial institution controlling said ATM terminal.

4. The method of claim 1 wherein said requested transaction is a request to provide cash from said target ATM terminal.

5. The method of claim 1 wherein said requested transaction is a transfer of funds to a wireless prepaid/postpaid account.

6. The method of claim 2 wherein said requested transaction is a transfer of funds from a bank card or credit card, further comprising the steps of:
inserting said bank card or credit card into said target ATM terminal; and
transmitting information from said bank card or credit card from said ATM terminal to a financial institution network for transmission to a payment server.

7. The method of claim 1 further comprising the step of:
transmitting transaction confirmation information to said ATM terminal, or to said cellular device or as e-mail to a customer requesting said transaction.

8. Apparatus for performing an automated teller machine (ATM) transaction comprising:
means for transmitting data from a cellular device, said data for identifying an ATM terminal, specifying a requested ATM transaction, and specifying a customer identification, toward means for accessing an account of said customer;
means, responsive to accessing said account, for transmitting a request to a financial institution controlling said ATM terminal; and
means for transmitting a request from said financial institution controlling said ATM terminal to said ATM terminal to complete said requested transaction.

9. The apparatus of claim 8 further comprising:
means, responsive to accessing said account, for transmitting a billing request to an automated clearing house; and
means for transmitting requests from said automated clearing house to a bank of said customer and to said financial institution controlling said ATM terminal to adjust customer balances and request inter-bank transfers corresponding to said requested ATM transaction.

10. The apparatus of claim 8 wherein the means for transmitting data toward means for accessing said account of said customer comprises:
means for establishing a connection from a cellular device of a customer to an application server of a telephony service provider network;
within said telephony service provider network, means for establishing a data connection between said application server and a payment server;
means for inputting data from said cellular device for identifying said customer and for specifying a requested ATM transaction; and
means for transmitting a request from said payment service server to a financial institution controlling said ATM terminal.

11. The apparatus of claim 8 wherein said requested transaction is a request to provide cash from said target ATM terminal.

12. The apparatus of claim 8 wherein said requested transaction is a transfer of funds to a wireless prepaid/postpaid account.

13. The apparatus of claim 9 wherein said requested transaction is a transfer of funds from a bank card or credit card, further comprising:
means for accepting said bank card or credit card in said ATM terminal; and
means for transmitting information from said bank card or credit card from said ATM terminal to a financial institution network for transmission to a payment server.

14. The apparatus of claim 8 further comprising:
means for transmitting transaction confirmation information to said ATM terminal, or to said cellular device or as e-mail to a customer requesting said transaction.
